(19) United States
(12) Patent Application Publication
(10) Pub. No.: US 2003/0161494 A1
(43) Pub. Date: Aug. 28, 2003

(54) Acoustic transducer for broad-band loudspeakers or headphones

(76) Inventors: Frank Baumgart, Magdeburg (DE); Thomas Kaulisch, Berlin (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/240,665

(22) PCT Filed: Apr. 2, 2001
(86) PCT No.: PCT/EP01/03720

(30) Foreign Application Priority Data
Apr. 4, 2000 (DE) 100 18 032.9
Apr. 4, 2000 (DE) 100 18 033.7

(51) Int. Cl. H04R 1/00; H04R 9/06

(52) U.S. Cl. 381/426; 381/423

(57) ABSTRACT

The invention relates to an acoustic transducer for broad-band loudspeakers or magnet-free, electrodynamic head-phones for generating sound, especially for the use in the homogenous and/or inhomogeneous magnetic field of a magnetic resonance tomograph. According to the advantages of the invention, sound having defined characteristics can be generated in such a way that said sound is provided with good quality and high effectiveness within the strong magnetic field of a magnetic resonance tomograph. In addition to music and voice, this comprises the generation of sound for actively controlling noise by generating sound by means of one or several membranes (1) that form air pockets. Said membranes (1) consist of elastic, non-magnetic or slightly magnetic material and are connected to strip conductors (2) in a two-dimensional and solid manner. A Lorentz force which is caused by the magnetic field of the magnetic resonance tomograph is exerted on said strip conductors as the driving power when current flows.

### DESCRIPTION

The invention relates to an acoustic transducer for broadband loudspeakers or magnet-free, electrodynamic headphones for sound generation, especially for use in a homogenous and/or inhomogeneous magnetic field of a magnetic resonance tomograph.

Generation of sound, especially with strictly defined properties and in high quality, such as, e.g., music, speech and antisound, is a problem in areas with strong magnetic fields, since conventional electrodynamic loudspeakers or acoustic transducers located in headphones in these environments are exposed to strong forces and can in addition disrupt the application based on the strong magnetic field. Modern methods of nuclear spin tomography for video display of, e.g., brain function and cardiac function disorders are limited in use and clinical popularity by their high acoustic emissions, which can only be inadequately counteracted in the low frequency range by passive measures, (Journal “British Journal of Radiology”, 1994, number 67, pages 413 to 415; journal “Radiology”, 1994, number 191, pages 91 to 93 in conjunction with the “Recommendation of the Radiation Protection Commission passed at the 131st session on Jun. 22, 1995”, page 17). Even below the legal boundary values, acoustic emissions represent a reduction in patient comfort and communications possibilities and thus patient safety. Active noise control (“antisound”) represents a promising method for reducing acoustic emission of MRT systems journal “Radiology”, 1989, number 173, pages 549 to 550, and journal “Proceedings of the Society of Magnetic Resonance” 1995, number 2, page 1223). Effective extinguishment of disturbing noise for frequencies up to roughly 1 kHz is only possible, however, when the antinoise loudspeaker has a very short three-dimensional distance to the source of disturbing noise (the gradient tube within the MRT magnet) and the antinoise loudspeaker can reflect the acoustic field of the noise source.

To date, no acoustic generator compatible with magnetic resonance tomographs which adequately meets these requirements has been described.

To date, loudspeakers which are designed for noise control directly in the tomograph and which use the inhomogeneous portion of the magnetic field for electrodynamic coupling are suitable, depending on design, only up to tone levels of roughly 1 kHz, and, moreover, they cannot be installed in the homogeneous area of the magnetic field (DE 197 27 657 C1).

Arrangements for extinguishing acoustic waves based on the principle of generating a signal phase-shifted by 180° have been repeatedly described outside of magnetic resonance tomography as well (DE 195 28 888 A1), but in the area of magnetic resonance tomography, they cannot be used as a result of the circumstances prevailing there.

Earlier developments of disruptive noise suppression systems in magnetic resonance tomography are limited to reducing disturbing noise to improve patient monitoring outside of the magnetic resonance tomograph in a control space which is acoustically insulated from the magnetic resonance tomograph. Here, moreover, antinoise is not produced, but rather a signal reduced by the disturbing noise signal using suitable adaptive filters is output with a conventional loudspeaker within the control space which is free of magnetic fields (EP 0 655 730 A1).

An electrodynamic loudspeaker suitable for use within the homogeneous part of the magnetic field of a magnetic resonance tomograph without its own magnets using ferromagnetic field inhomogenizers and flexible conductor systems for relaying the generated sound has already been described (U.S. Pat. No. 005,450,499 A). Based on the flexible conductor system used, however, this yields neither the acoustic pressures necessary for producing antinoise over the required frequency band in a defined phase relation, nor does the use of essentially ferromagnetic components allow the safe handling to be unconditionally demanded in spaces penetrated by magnetic fields. Furthermore, when using ferromagnetic components within the originally homogeneous part of the magnetic field interference with imaging arises due to the local generation of undefined magnetic field inhomogeneities.

The displacer principle underlying the invention has also already been described elsewhere, especially the reduction of the effective mass by forming air pockets (DE 2003 950, U.S. Pat. No. 4,039,044, U.S. Pat. No. 4,160,883). The effective mass is reduced by the use of a membrane which is suitably driven and which displaces the air present in the air pockets which have been formed. The desired high ratio of width to depth of the air pockets is limited here by the relatively small spatial extension of the magnetic field.

More recent approaches relate to the more detailed configuration of the membranes and magnets, but all use their own magnets in the form of pole shoes or the like (U.S. Pat. No. 5,912,863) without solving the problem of spatial extension and generation of the magnetic field.

One important objective of the invention is to reduce the noise burden by the MRT system during examination. Noise muffling with passive systems (e.g., earplugs) is psychoacoustically ineffective, since hearing reacts more sensitively in a comparable amount to the achieved muffling. Active systems consisting of headphone systems and ear muffs accomplish the same attenuation and no weakening of psychoacoustic effect—in contrast, loud music reduces sensitivity (“noise covering,” effect amplification) and the communications possibility with music is perceived as pleasant, increases comfort and reduces the break-off rate, and the patient does not lose the sense of time when listening to music.

Combined systems of ear muffs and headphone systems are known and described in MRT. There are different systems with specific advantages and disadvantages, for example a modified cone-type loudspeaker without its own magnets is described as a headphone system. This system is durable and economical, but it is not able to transmit low tones (below 300 Hz). Systems with piezo loudspeakers are also described; what was stated above applies to this combination, only here the lower cutoff frequency is still higher (design dictated at 500-800 Hz). Combinations with electrostatic headphones are likewise described and commercially available. These systems have a frequency response which extends down relatively low—their acoustic properties are very good. They have several disadvantages, however. In particular they are expensive, the sound muffling of earmuffs is greatly reduced since the large membrane no longer allows muffling materials on the side facing the ear, and they are very problematic in terms of safety engineering. The combination of headphone systems (capacitance) and cables (inductance) in the case of damage can constitute an oscillating circuit which picks up the high-frequency energy of the MRT transmitter. The system would quickly become very hot at ordinary transmitted powers, and there is the danger of burns.

The object of the invention is to provide an acoustic transducer for broadband loudspeakers or headphones that can be safely and reliably used in the magnetic field of a magnetic resonance tomograph without interfering with imaging, satisfies high quality requirements in a wide frequency range, enables active noise control, can be easily and economically produced and can be combined in the implementation as a headphone with ear muffs.

This object is achieved by the features of claim 1. Feasible embodiments of the invention are contained in the dependent claims.

The invention in the embodiment as headphones addresses the problem that the high disruptive sound levels of MRT systems can be effectively reduced by active noise control if a high-power antisound generator can be installed in the gradient tube of the MRT system. In particular here the circumstance must be considered that handling of magnetic materials at the magnetic field flux densities used at present (1 T to 3 T in clinical operation) represents an extremely high danger potential.

The advantages achieved with the invention consist in that sound with defined properties can be produced in high quality and with high efficiency within the strong magnetic field of a magnetic resonance tomograph. In addition to music and voice, it also encompasses the generation of sound for active noise control, as cannot be done with flexible conductor systems, and can be done with other electrodynamic transducers only in the inhomogeneous area of the magnetic field and in lower quality.

The advantages of folded membranes are especially well used when it is possible to build up a relatively large, relatively strong and homogeneous magnetic field, such as that of a nuclear spin tomograph, around the membrane.

Loudspeakers can be mounted anywhere within the magnetic resonance tomograph and thus optimally matched according to the respective purpose. For use as antisound loudspeakers, this aspect is important. The loudspeaker has a wide frequency band, and especially tones above a frequency of 1 kHz can be produced. At the same time, the applied principle of a drive which acts uniformly on all parts of the loudspeaker membrane ensures that the bending vibrations and distortions which occur in a conventional, local cone drive do not occur.

Use in a magnetic resonance tomograph enables a membrane of essentially any extent as a result of the magnetic field which is three-dimensionally more extensive compared to the practical dimensions of the loudspeaker. The possible effective mass which is extremely low for this reason leads to high efficiency and a transmission behavior which is uniform over wide frequency ranges. At the same time, there is the possibility of effective generation of low tones by the use of a large membrane surface.

In magnetic resonance tomographs, a hitherto unprecedentedly large ratio of fold depth to fold height can be accomplished. The effective mass of the loudspeaker membrane is thus very small. Thus, e.g., at a fold depth of 200 mm and a fold height of 10 mm, the effective mass of the membrane is reduced by a factor of 420 relative to the actual mass. This in turn means that the acoustic stiffness of the membrane becomes very high and becomes almost independent of its mechanical properties. This enables distortion-free acoustic emission even at high acoustic pressures. The efficiency of acoustic generation is likewise increased since the losses due to positive and negative acceleration of the effective membrane mass are low.

According to the invention, in headphones an unprecedentedly large ratio of fold depth to fold height can also be achieved. The effective mass of the transducer membrane is also very low for this reason, and the acoustic stiffness of the membrane is very high and becomes almost independent of its mechanical properties.

A large fold area enables application of many electrically conductive elements located parallel to one another, preferably flat wires. The conductive elements are also electrically connected in parallel and thus yield a very low ohmic resistance of the arrangement. The electrical losses are thus minimized, and no heat develops in the individual elements. The operating reliability and the service life of the acoustic generator are greatly increased thereby. Furthermore, the arrangement compared to the described metal bands (DE 2003 950) has the advantage that only very low eddy currents can be produced in the conductive elements by the strong magnetic alternating fields produced by a nuclear spin tomograph in imaging with a frequency of up to 1500 Hz. This in turn prevents heating of the conductive elements and especially has no disturbing influences on the magnetic gradient fields of nuclear spin tomographs.

The magnetic field intensities (up to 3 T) of a nuclear spin tomograph which are atypically large for acoustic transducers at low audio-frequency currents convey a large drive force (Lorentz force) to the membrane which is firmly connected to it by the electrically conductive elements. This enables effective acoustic emission even at low current intensities. The magnetic fields produced by these currents are accordingly low and do not adversely affect the homogeneity of the main field, i.e., they do not have a disturbing effect on imaging.

Completely abandoning ferromagnetic materials enables handling of an antisound loudspeaker which is safe under all circumstances. Otherwise, ferromagnetic parts can be accelerated like a shot in the direction of the center of the permanent magnetic field. No safety measures for controlling the ferromagnetic forces in the vicinity of MRT magnets are necessary.

Some embodiments are shown in the drawings and are described in more detail below.

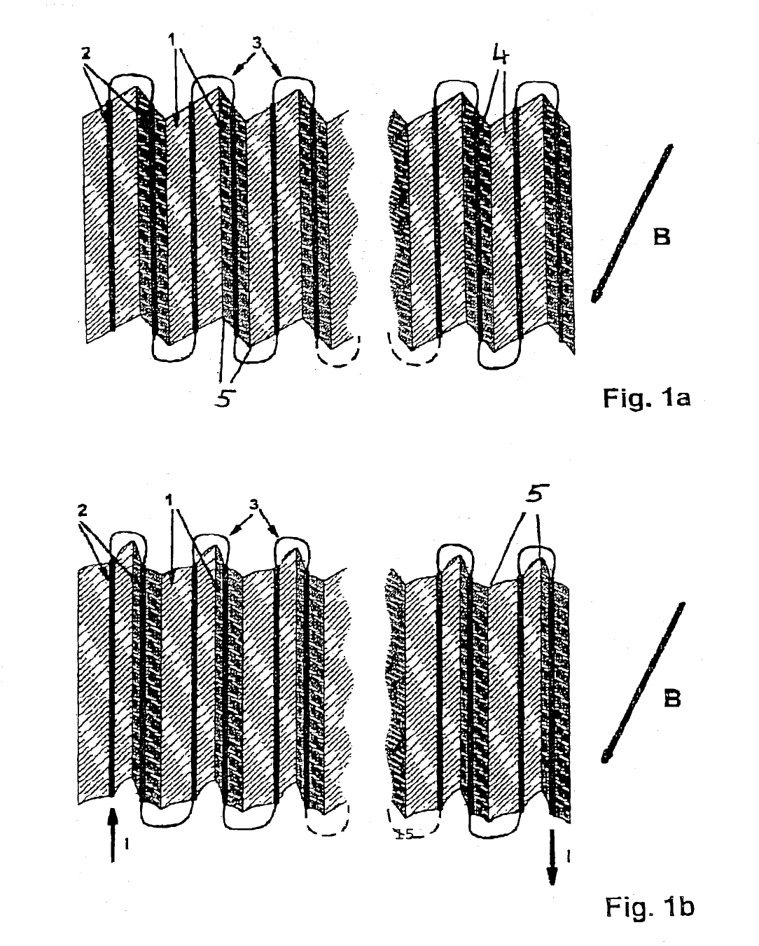

FIG. 1a shows a folded membrane with series-connected printed conductors that run parallel to the fold axes,

FIG. 1b shows the change of the membrane according to FIG. 1a when a current flows through the printed conductors,

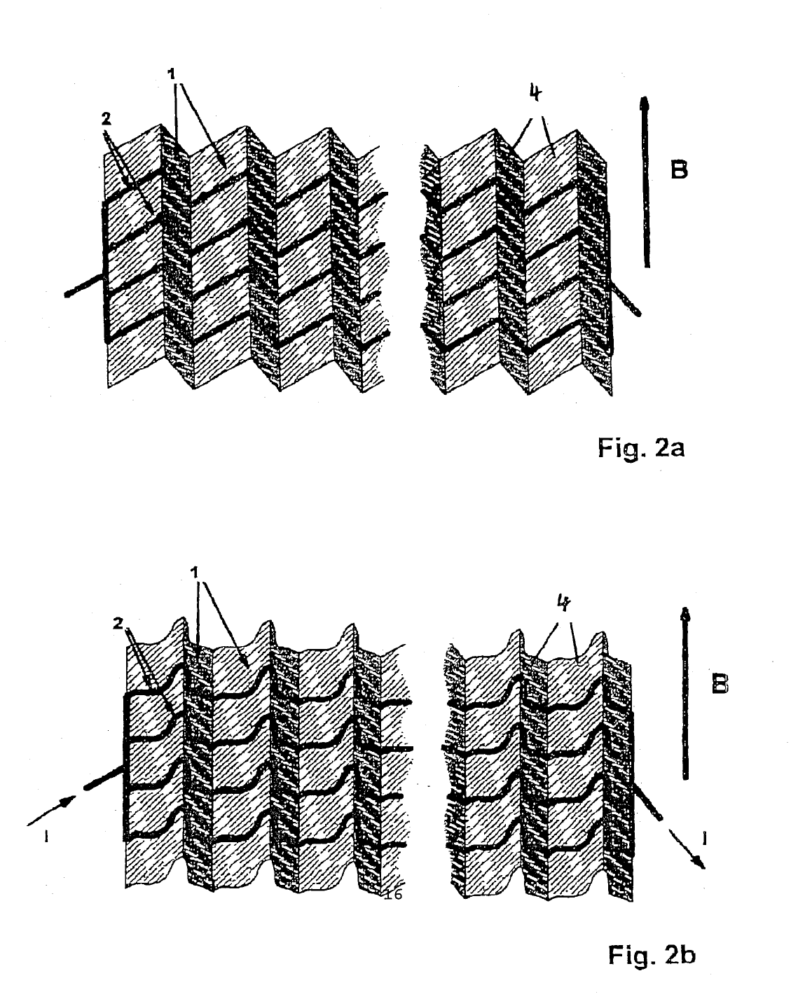

FIG. 2a shows a folded membrane with parallel-connected printed conductors which run orthogonally to the fold axes,

FIG. 2b shows the change of the membrane according to FIG. 2a when a current flows through the printed conductors,

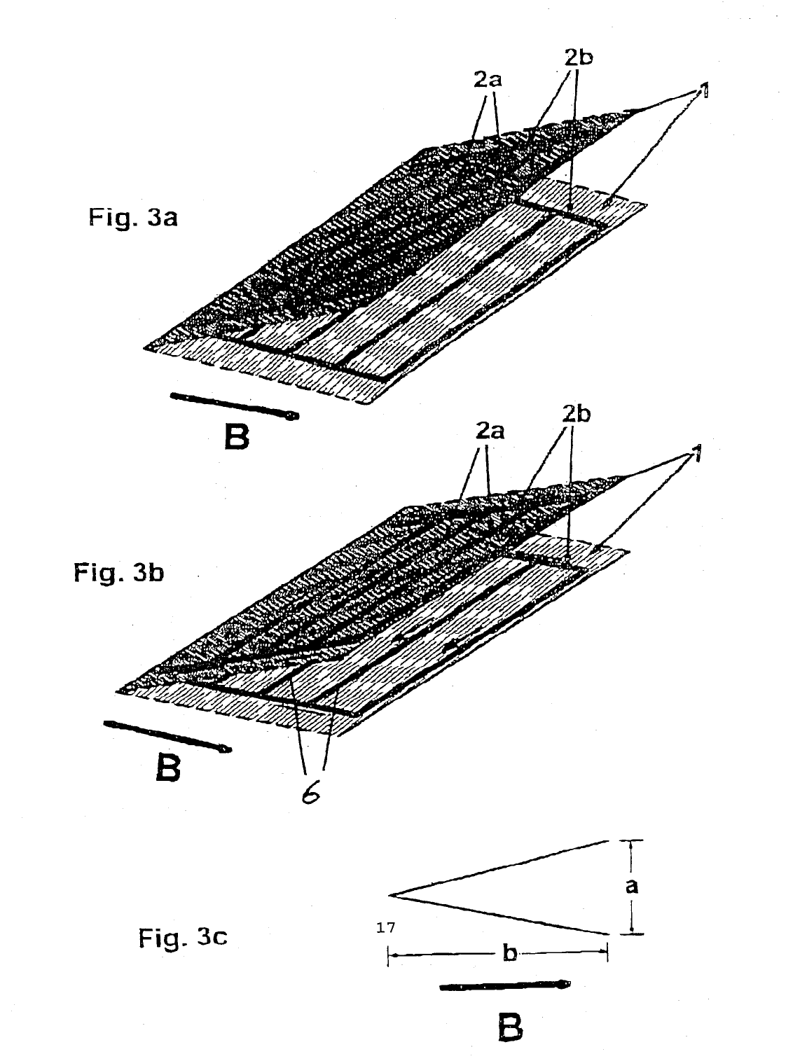

FIG. 3a shows a membrane with a printed conductor block,

FIG. 3b shows the change of the membrane according to FIG. 3a when a current flows through the printed conductors,

FIG. 3c shows the ratio of the air pocket width to the air pocket depth.

FIG. 1a shows one possible embodiment in which the membrane 1, consisting of elastic material which is not magnetic or which is only weakly magnetic, e.g., paper, nonwoven or plastic, along an axis that is orthogonal to the magnetic field B of the magnetic resonance tomograph or almost orthogonal to it, is folded into one or more folds or corrugations, or a corresponding arrangement is formed by several individual membranes which are movably connected to one another. Along the air pockets formed in this way by the surfaces 4 on either side, one or more printed conductors 2 at a time are each connected two-dimensionally and securely to the membrane 1, such that the direction of the printed conductors runs parallel or almost parallel to the fold or bending axes. The printed conductors 2 are interconnected among one another by electrical connections 3 such that the same electrical current in the opposite orientation flows through the printed conductors 2 on the surfaces 4 of an air pocket that are opposite to one another.

FIG. 1b shows the arrangement shown in FIG. 1a when a current I flows through the printed conductors 2. The external magnetic field B of the magnetic resonance tomograph conveys a deflecting force to the printed conductors 2, whose orientation is determined by the direction of the flowing current. A conductor arrangement as described results in that the air pockets are narrowed on one side of the folded or corrugated membrane surface 4 by printed conductors 2 which move toward one another, while the air pockets that are located on the other side of the folded membrane are widened. An audio-frequency current leads to joint opening and closing of the air pockets in the same direction on both sides of the folded or corrugated membrane 1. The pressure fluctuations caused by these movements within the swept air volume are emitted as an acoustic wave on both sides perpendicular to the overall membrane surface. The efficiency of this arrangement is optimum when the magnetic field B of the magnetic resonance tomograph is oriented perpendicular to the folded or corrugated overall membrane surface. Deviation from this geometry, whether by curvature or turning of the entire arrangement or parts thereof, reduces the efficiency, but without calling into question serviceability.

For headphones, any deviation from this geometry, whether by curvature or turning of the entire arrangement or parts thereof, is meaningful. The efficiency of acoustic generation is reduced and thus the emitted acoustic energy is reduced to the safe values conventional for headphones. The headphones can then be operated with an electrical power as is conventionally made available by headphone outputs of audio equipment.

The membrane is inserted into the ear muffs such that it is aligned almost parallel to the main field of the nuclear spin tomograph when being worn. The remaining space in the ear muffs is filled with acoustic attenuation materials so that passive muffling is preserved.

FIG. 2a shows one embodiment in which the membrane 1 along an axis that is parallel to the magnetic field B of the magnetic resonance tomograph or almost parallel is folded into one or more folds or corrugations, or a corresponding arrangement is formed by several individual membranes movably connected to one another. One or more flexible printed conductors 2 are connected two-dimensionally and securely to the membrane 1 such that the direction of the printed conductors 2 runs orthogonally or almost orthogonally to the fold or bending axes 5. The printed conductors 2 that have been attached in this way are electrically connected in parallel.

FIG. 2b shows the arrangement shown in FIG. 2a when a current I flows through the printed conductors 2. The external magnetic field B of the magnetic resonance tomograph conveys a deforming force to the printed conductors 2, whose orientation is determined by the direction of the flowing current. A conductor arrangement as described results in that the air pockets are narrowed on one side of the folded or corrugated membrane 1, while the air pockets located on the other side of the folded membrane 1 are widened. An audio-frequency current leads to joint opening and closing of the air pockets in the same direction on both sides of the folded or corrugated membrane 1. The pressure fluctuations caused by these movements within the swept air volume are emitted as an acoustic wave on both sides perpendicular to the overall membrane surface. The efficiency of this arrangement is optimum when the magnetic field B of the magnetic resonance tomograph is oriented perpendicular to the printed conductors 2. Deviation from this geometry, whether by curvature or turning of the entire arrangement or parts thereof, reduces the efficiency, but without calling into question serviceability.

FIG. 3a shows the active part of one embodiment (without a holding device) in which the membrane 1 along an axis that is orthogonal to the magnetic field B of the magnetic resonance tomograph or almost orthogonal to it is folded into one or more folds or corrugations, or a corresponding arrangement is formed by several individual membranes which are movably connected to one another. One or more conductors that are being used as feed lines 2b are connected two-dimensionally and securely to the membrane 1 such that the direction of the conductors runs orthogonally or almost orthogonally to the fold or bending axes. In addition, parallel or almost parallel to the fold axis and thus orthogonally or almost orthogonally to the direction of the magnetic field B of the magnetic resonance tomograph, one or more printed conductors 2a are joined two-dimensionally or securely to the membrane 1. The printed conductors 2a are electrically connected parallel to the feed lines 2b on both sides of the air pocket formed by the membrane 1. Current must be supplied such that the same electrical current flows through the printed conductors 2a on opposite sides of the air pocket in an opposite orientation.

Several printed conductors 2a are interconnected by means of feed lines 2b into printed conductor blocks 6.

FIG. 3b shows such an arrangement when current 1 flows through. The force conveyed when current flows through the printed conductors 2 by the magnetic field B results in that the air pocket formed by the folded membrane 1 is widened or narrowed. An audio-frequency current within the swept air pocket causes a pressure fluctuation in the same direction, which is emitted as an acoustic wave.

The arrangement shown in FIGS. 3a and 3b enables eddy current-free driving of the membrane 1 over a large area by applying several parallel, active printed conductors 2a. If the spatial extension of the magnetic field B of the magnetic resonance tomograph, which extent is large compared to the dimensions of a transducer, is considered, execution of a transducer is possible with additionally increased efficiency, since the ratio of air pocket width a to air pocket depth b which determines efficiency (see FIG. 3c) can be reduced by increasing the depth b.

The invention is not limited to the embodiments described here. Rather it is possible to implement other variant embodiments by suitable combination of the above-mentioned means and features without departing from the framework of the invention.

1. Acoustic transducer for broadband loudspeakers or headphones for sound generation and for use in a homogenous and/or inhomogeneous magnetic field of a magnetic resonance tomograph,
characterized in that
sound generation takes place by one or more membranes (1) that form air pockets, whereby the membranes (1) consist of elastic, nonmagnetic or weakly magnetic material and are connected two-dimensionally and securely to printed conductors 2 on which a Lorentz force conveyed by the magnetic field of the magnetic resonance tomograph acts as a driving power when current flows.

2. Acoustic transducer according to claim 1, wherein the air pockets are formed by the surfaces (4) of the membranes (1), and the surfaces (4) are bordered by the fold or bending axes (5).

3. Acoustic transducer according to claim 2, wherein the printed conductors (2) run parallel to the fold or bending axes (5) and are electrically connected in series.

4. Acoustic transducer according to claim 2 or 3, wherein several printed conductors (2a) are interconnected by means of feed lines (2b) into a printed conductor block (6), and the printed conductor blocks (6) run parallel to the fold or bending axes (5).

5. Acoustic transducer according to claim 2, wherein the printed conductors (2) run orthogonally or almost orthogonally to the fold or bending axes (5).

6. Acoustic transducer according to claim 5, wherein several printed conductors (2) are electrically connected in parallel.

7. Acoustic transducer according to claim 1, wherein to increase efficiency two or more membranes 1 are arranged such that deflection pointed in the opposite directions accomplishes displacement of a larger air volume.

8. Acoustic transducer according to claim 1, wherein current flow through the printed conductors 2 takes place in an orientation which is opposite on alternating sides by folding up one of more membranes 1 and by attachment of the printed conductors 2 along the surfaces 4.

9. Acoustic transducer according to claim 1, wherein the additional magnetic field which has built up in the vicinity of the loudspeaker is minimized by the compensatory arrangement of the printed conductors 2.

10. Acoustic transducer in an implementation as a loudspeaker according to claim 1, wherein it is made as lining of the inside walls of the tomograph with folds (volume loudspeaker).

11. Acoustic transducer in an implementation as a loudspeaker according to claim 1 for use as an antinoise loudspeaker.

12. Acoustic transducer in an implementation as a loudspeaker according to claim 1 for use within part of a two-way intercom system, the part being located in the magnetic resonance tomograph.
